(19) United States
(12) Patent Application Publication
(10) Pub. No.: US 2024/0395484 A1
(43) Pub. Date: Nov. 28, 2024

(54) HOUSING FOR A VACUUM INTERRUPTER

(71) Applicant: Siemens Aktiengesellschaft, München (DE)

(72) Inventors: Christian Stiehler, Berlin (DE); Frank Graskowski, Wandlitz (DE); Erik D Taylor, Berlin (DE); Jörg Teichmann, Dallgow-Döberitz (DE); Thomas Heinz, Berlin (DE)

(21) Appl. No.: 18/696,480

(22) PCT Filed: Aug. 16, 2022
(86) PCT No.: PCT/EP2022/072797

§ 371 Date: Mar. 28, 2024

(30) Foreign Application Priority Data
Sep. 28, 2021 (DE) 10 2021 210 859.8

(51) Int. Cl. H01H 33/662

(52) U.S. Cl. CPC H01H 33/66207

(57) ABSTRACT

A housing for a vacuum interrupter accommodates an axially movable moving contact rod, which carries a moving contact, and a fixed contact rod, which carries a fixed contact. The arrangement of the moving contact rod and the fixed contact rod in the housing defines a division of the housing into a moving contact half and a fixed contact half. In each of the moving contact half and the fixed contact half, a portion of the housing surrounding the longitudinal axis of the housing is formed by an electrically insulating insulation component. The insulation component in the moving contact half and the insulation component of the fixed contact half have different dimensions.

The invention relates to a housing for a vacuum interrupter, and to a vacuum interrupter.

The in most instances tubular isolators of vacuum interrupters (VSR), which are composed of e.g. aluminum-oxide ceramics glazed outside, glass ceramics or glass, form a leakage-current resistant external insulation of the housing when the switching path is opened. In slim and in comparatively large housings, the isolators are often configured as two isolator components which are separated by a metallic central part, e.g. made of steel sheet, cf. e.g. EP0082801A1 (Siemens AG) of Jun. 29, 1983 and DE19713478C1 (Siemens AG) of Apr. 9, 1998.

To date, VSRs having at least two isolator components, e.g. ceramic hollow cylinders, are of a symmetrical design, i.e. the number, the diameter as well as the length of the isolator components in the two housing halves, specifically in the housing half of the moving contact rod of the VSR that supports the moving contact (BK), the so-called moving contact half, and in the housing half of the stationary contact rod that supports the fixed contact (FK), the so-called fixed contact half, are identical.

In switch applications having VSRs, in particular having grounded housings, e.g. GIS (gas insulated switchgear) and a dead tank, an asymmetrical distribution of voltage May arise on the VSR. Depending on the installed position of the VSR, the asymmetry may prevail in the BK-half or the FK-half of the VSR.

Typically, the voltage load in the moving contact half is higher than the voltage load in the fixed contact half, cf.

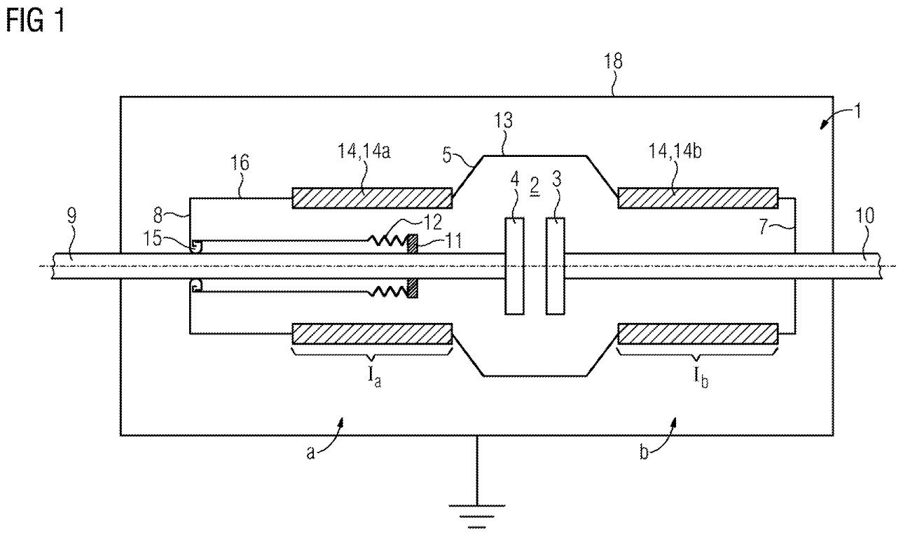

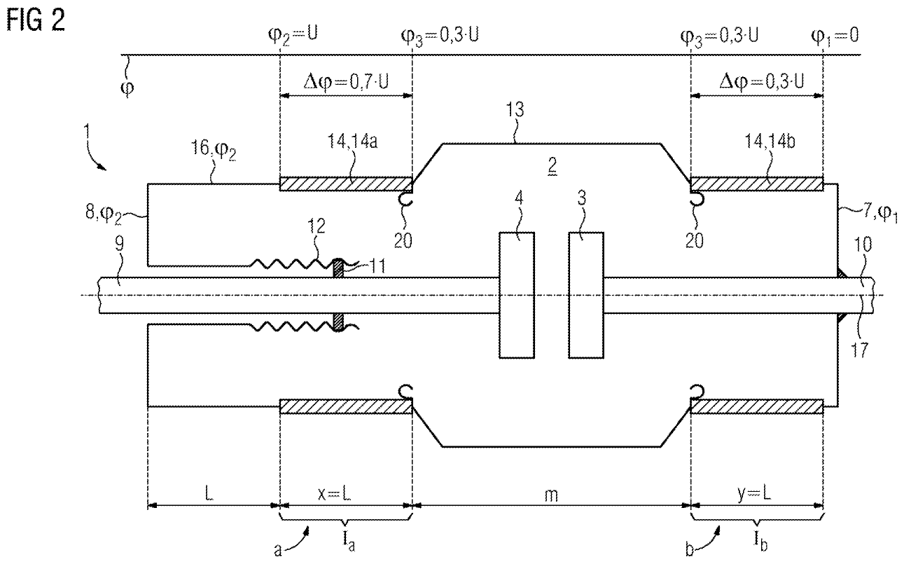

FIGS. 1 and 2. Accordingly, the dielectric rating of the VSR is determined by the voltage load in the moving contact half. As a result, the fixed contact half of the housing is potentially dielectrically overrated.

It is thus an object of the present invention to provide an improved housing of a VSR.

This object is achieved according to the invention by a housing as claimed in independent claim 1. Advantageous design embodiments of the housing according to the invention and of a vacuum interrupter are the subject matter of the dependent claims.

The housing is suitable for a vacuum interrupter. It is designed for receiving an axially movable moving contact rod supporting a moving contact and a fixed contact rod supporting a fixed contact. The moving contact rod is also referred to as a moving contact connection pin or contact bar in the technical literature.

The vacuum interrupter has a switching chamber which is enclosed by the housing and in which are disposed the fixed contact and the moving contact. The moving contact sits on one end of the moving contact rod, the latter leading out of the vacuum interrupter in an axially movable manner. The moving contact can be moved relative to the fixed contact by an axial movement of the moving contact rod. The moving contact rod runs through a cover of the housing in a vacuum-tight manner; for this purpose, the cover has an insertion opening in its cover base, the moving contact rod leading through said insertion opening.

The feedthrough of the moving contact rod through the insertion opening of the cover base is kept vacuum-tight by means of a metallic bellows. The bellows is a metallic corrugated tube which by virtue of its multiplicity of corrugations can be axially elongated and compressed in such a way that the axial movement of the moving contact rod required in switching procedures of the vacuum interrupter is possible without posing a risk to the vacuum tightness in the region of the feedthrough of the moving contact rod through the cover base.

Defined as a result of the provided arrangement of the moving contact rod and the fixed contact rod in the housing is a division of the housing into a moving contact half and a fixed contact half: that housing half in which the moving contact rod is disposed is referred to as the moving contact half, and that housing half in which the fixed contact rod is disposed is referred to as the fixed contact half. In each of the moving contact half as well as the fixed contact half a portion of the housing enclosing the longitudinal axis of the housing is formed by an electrically isolating isolator component. An isolator component thus forms an isolation section along the housing, when viewed in the direction of the longitudinal axis of the housing.

According to the invention, the isolator component in the moving contact half and the isolator component in the fixed contact half have different dimensions.

By using isolator components with different dimensions in the moving contact half and the fixed contact half, the specific asymmetrical voltage load of VSRs in interrupter housings, in particular grounded interrupter housings, can be taken into account. The isolator components form a leakage-current resistant external insulation of the housing when the switching path is opened. The isolator components herein are adapted to the respective voltage conditions of the housing in such a way that this results in an improved insulation strength. Adapting the dimensions of the isolator components to the specific voltage load offers the advantage of a smaller construction mode of VSRs and interrupter devices, which is associated with a reduction in terms of cost of the VSRs and the interrupter devices.

According to a preferred embodiment of the invention, the isolator components in the moving contact half and the fixed contact half, when measured along the longitudinal axis of the housing, have different lengths. By using isolator components of different lengths in the moving contact half and the fixed contact half, the specific asymmetrical voltage load of VSRs in interrupter housings can be taken into account. The isolator components herein are adapted to the respective voltage conditions of the housing in such a way that this results in an improved insulation strength.

According to a preferred embodiment of the invention, the isolator component in the moving contact half is longer than the isolator component in the fixed contact half. By using a longer isolator component in the moving contact half than in the fixed contact half, the specific asymmetrical voltage load of VSRs in interrupter housings can be taken into account. The isolator components herein are adapted to the respective voltage conditions of the housing in such a way that this results in an improved insulation strength.

In the case of large construction lengths of VSRs, long metallic BK flanges, which are necessitated by the use of long bellows for a long service life at a corresponding number of contact strokes, can be shortened in that a longer isolator component is used in the moving contact half. This measure has the following advantages:
A modified flange and a longer ceramic housing can lead to a reduction in costs.
Long BK flanges which are occasionally difficult to manufacture, or are cost-intensive, can be avoided.
This results in an enhanced stability of the VSR housing in the direction of the longitudinal axis of the housing, because an isolator component is stiffer than a metallic BK flange of stainless steel, for example.
This results in an increased compressive strength of the VSRs, because BK flanges, e.g. stainless steel flanges, with long legs that tend to buckle under comparatively high compression can be avoided.

Moreover, unfavorable tolerance positions in an interrupter housing can be compensated for by a vacuum interrupter of asymmetrical design, e.g. when the isolator component in the moving contact half is longer than the isolator component in the fixed contact half. For example, it can be ensured by a lengthened isolator component in the moving contact half that the dielectrically required clearance across the isolator component in the moving contact half is not undershot even in the case of an unfavorable tolerance position, e.g. by virtue of component lengths, by virtue of a slow change in a component length caused by stress on the component by for instance a spring, or when components with different coefficients of thermal expansion heat up.

According to one preferred embodiment of the invention, the isolator component in the moving contact half and the isolator component in the fixed contact half have different internal diameters. It is also possible for an isolator component to have a plurality of different internal diameters, e.g. in the case of a conical or stepped shaped of the isolator component: the isolator component has a first internal diameter at a first position along the housing axis, and the isolator component has a second internal diameter, smaller or larger than the first internal diameter, at a second position along the housing axis, different from the first position. According to one preferred embodiment of the invention, at least one of different internal diameters of the isolator component in the moving contact half or the fixed contact half is different from the internal diameter of the isolator component in the other housing half. By using isolator components which have different diameters in the moving contact half and the fixed contact half, the specific asymmetrical voltage load of VSRs in interrupter housings can be taken into account. The isolator components herein are adapted to the respective voltage conditions of the housing in such a way that this results in an improved insulation strength. Diameter variations can be implemented by conical ceramics, stepped ceramics and diameter jumps between individual ceramics. Dielectric loads can be reduced, and/or the vapor deposition protection can be improved, as a result.

According to one preferred embodiment of the invention, the isolator component in the moving contact half has a larger internal diameter than the isolator component in the fixed contact half. By using an isolator component which has a larger internal diameter in the moving contact half than the isolator component in the fixed contact half, the specific asymmetrical voltage load of VSRs in interrupter housings can be taken into account. The isolator components herein are adapted to the respective voltage conditions of the housing in such a way that this results in an improved insulation strength.

According to one preferred embodiment of the invention, the isolator components are in each case formed by one insulation material hollow cylinder, or by a plurality of insulation material hollow cylinders joined to one another. The insulation material hollow cylinders can be composed of aluminum-oxide ceramics glazed outside, glass ceramics or glass.

Field control elements or shields which lie between the ceramics and the switching chamber can be provided in order to reduce the dimensions of the VSR. By using a plurality of insulation material hollow cylinders joined to one another, e.g. ceramic hollow cylinders, it is possible for a further field control element or shield, e.g. a floating shield, to be incorporated between the insulation material hollow cylinders. This measure has the following advantages:
It offers the possibility of additionally optimizing the dielectric tube properties.
This results in an improved vapor deposition protection in the interior of the VSR.

According to one preferred embodiment of the invention, a metallic hollow cylinder is disposed as a switching chamber between the isolator component in the moving contact half and the isolator component in the fixed contact half. This metallic hollow cylinder serves as a condensation trap for the metallic vapor created, on the one hand. On the other hand, a metallic switching chamber offers greater possibilities in terms of design than e.g. ceramics, with a view to adapting the tube housing to the geometry of the current path in an ideally precise manner.

According to one preferred embodiment of the invention, a metallic hollow cylinder serving as a switching chamber and/or field control elements are disposed within the isolator components, i.e. positioned in front of the inner shell face of the isolator components, which can be configured as e.g. ceramics, when viewed from the longitudinal axis of the VSR.

A further preferred embodiment of the invention is a vacuum interrupter having a housing according to the invention.

According to one preferred embodiment of the invention, the vacuum interrupter is enclosed by a metallic housing.

The above-described properties, features and advantages of this invention and the manner in which they are achieved become clearer and more distinctly comprehensible in connection with the following description of the drawings, in which in a schematic illustration which is not true to scale:

FIG. 1 shows a section through a conventional vacuum interrupter in a “dead tank” housing;

FIG. 2 shows an enlarged illustration of the vacuum interrupter 1 shown in FIG. 1;

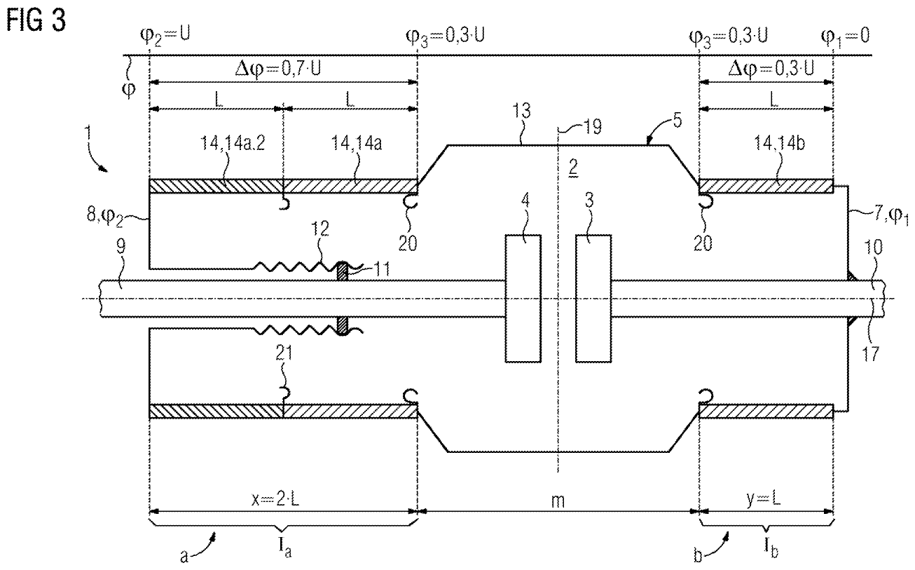

FIG. 3 shows a section through a vacuum interrupter according to the invention and according to a first embodiment;

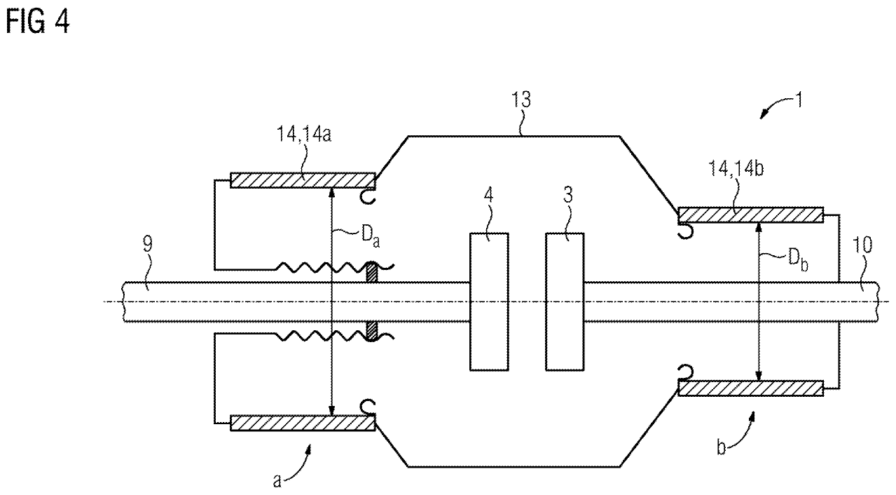

FIG. 4 shows a section through a vacuum interrupter according to the invention and according to a second embodiment;

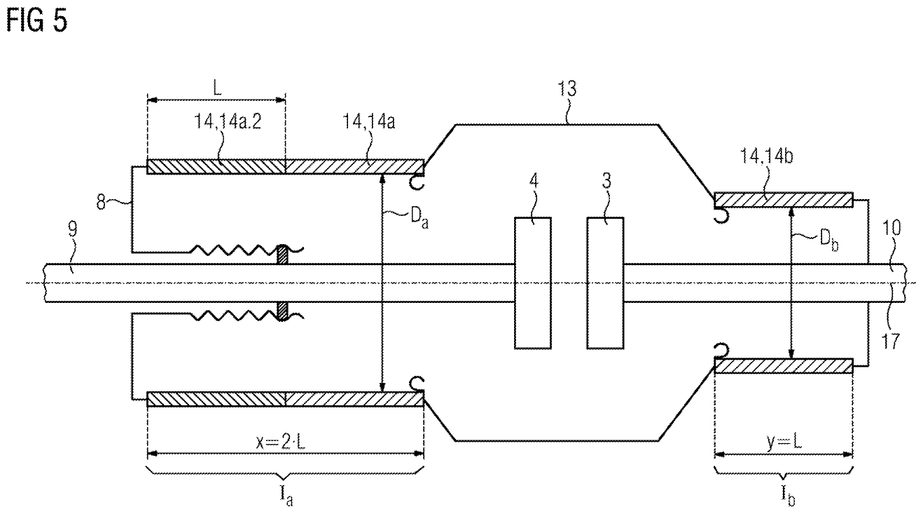

FIG. 5 shows a section through a vacuum interrupter according to the invention and according to a third embodiment;

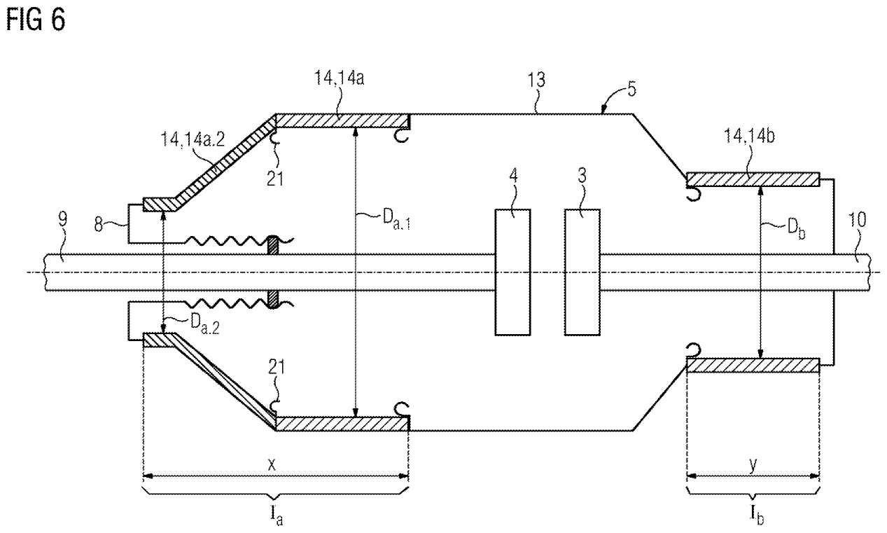

FIG. 6 shows a section through a vacuum interrupter according to the invention and according to a fourth embodiment; and

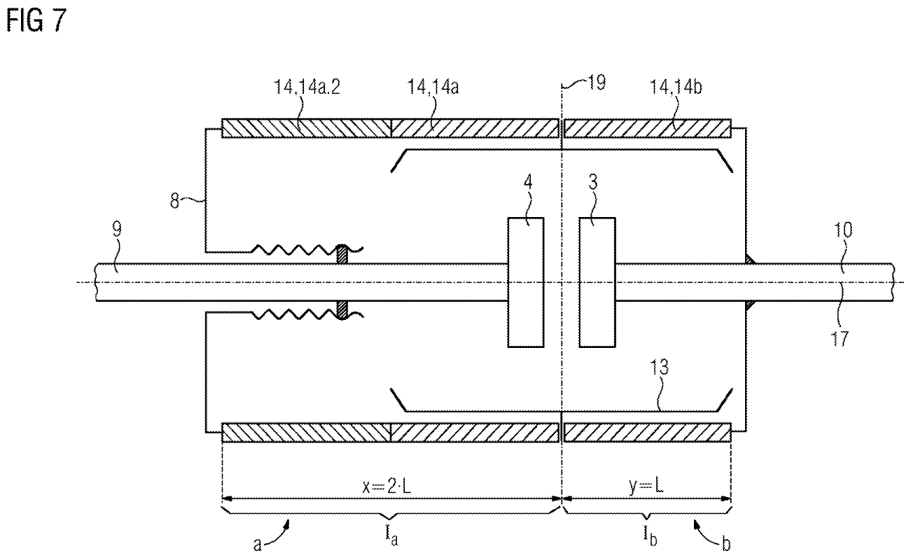

FIG. 7 shows a section through a vacuum interrupter according to the invention and according to a further embodiment.

FIG. 1 shows a section through a vacuum interrupter 1 which is known from the prior art and is disposed within a grounded metallic “dead tank” housing 18. The vacuum interrupter 1 has a housing 5 which encloses a switching chamber 2. A fixed contact 3 and a moving contact 4 are disposed in the switching chamber. The fixed contact 3 sits on one end of a fixed contact rod 10 which in a vacuum-tight manner leads out of the vacuum interrupter 1 and the “dead tank” housing 18 through a first metallic cover 7, said vacuum tightness being achieved, e.g. by soldering/brazing the fixed contact rod 10 and the first cover 7. The moving contact 4 sits on an end of a moving contact rod 9 which by means of a bearing 15 fixed to a second cover 8, is guided so as to be displaceable and secured against rotation, and leads out of the vacuum interrupter 1 and the “dead tank” housing 18 through the second cover 8. In a closing procedure the moving contact 4 can be brought into contact with the fixed contact 3, and in an opening procedure be brought to be spaced apart from the fixed contact 3, by means of the moving contact rod 9. The fixed contact 3 and the moving contact 4 are enclosed by a metal hollow cylinder 13 which forms the central part 13 of the VSR housing 5 and divides the vacuum interrupter 1 into a moving contact half a and a fixed contact half b.

In a symmetrical layout, one electrically isolating insulation material hollow cylinder 14, 14a, 14b, which forms an isolation section Iₐ on the moving contact half a, and an isolation section I_{b} on the fixed contact half b, respectively, is in each case disposed on both ends of the metal hollow cylinder 13. The insulation material hollow cylinders 14 can be formed from e.g. ceramics, such as an aluminum oxide. On the fixed contact half b of the vacuum interrupter 1, the end of the insulation material hollow cylinder 14b that faces away from the metal hollow cylinder 13 is closed by the first cover 7. On the moving contact half a of the vacuum interrupter 1, a cylindrically shaped moving contact flange 16 is disposed on the end of the insulation material hollow cylinder 14a that faces away from the metal hollow cylinder 13, the end of the moving contact flange 16 that faces away from the metal hollow cylinder 13 being closed by the second cover 8. The two covers 7 and 8, the moving contact flange 16, the two insulation material hollow cylinders 14a, 14b, and the metal hollow cylinder 13 disposed between the two insulation material hollow cylinders 14a, 14b, are coaxially disposed and conjointly form the vacuum-tight housing 5 of the vacuum interrupter 1.

The feedthrough of the moving contact rod 9 through the second cover 8 is kept vacuum-tight by means of metallic bellows 12, the first end thereof being disposed on the second cover 8, and the second thereof being attached to a protrusion 11, referred to as a bellows cap, of the moving contact rod 9, e.g. by a soldered/brazed connection.

FIG. 2 shows an enlarged illustration of the vacuum interrupter 1 shown in FIG. 1. Illustrated herein are the shields 20 integrally molded on the two ends of the metal hollow cylinder 13 of the length m. The length of the isolation section Iₐ of the moving contact half a, which is measured along the longitudinal axis of the vacuum interrupter 1 and is formed by the insulation material hollow cylinder 14a situated on the moving contact half a, is indicated by x; the length of the isolation section I_{b} of the fixed contact half b, which is measured along the longitudinal axis of the vacuum interrupter 1 and is formed by the insulation material hollow cylinder 14b situated on the fixed contact half b, is indicated by y; the values x and y can be a length, e.g. in the unit millimeters or, if the insulation material hollow cylinders 14 have a uniform length, an integer which indicates the number of insulation material hollow cylinders 14 disposed. In the conventional VSR housings: x=y (symmetrical layout). In the exemplary embodiment shown: x=y=L, whereby the moving contact flange 16 also has the length L.

The fixed contact 3 and the first cover 7 electrically connected thereto are situated on a first electrical potential φ₁. The moving contact 4, the second cover 8 electrically connected thereto, and the moving contact flange 16 are situated on a second electrical potential φ₂. In the present example, the first potential φ₁ has the value 0 (Volt); the second potential φ₂ has the value U (Volt). An electric field simulation of the vacuum interrupter 1, in which x=y, has demonstrated that this results in the voltage distribution shown in FIG. 2: The metal hollow cylinder 13 lies on a third electrical potential φ₃ of 0.3 U. There is thus a potential difference (=voltage) of Δφ=0.3 U between the two ends of the insulation material hollow cylinder 14b which is disposed on the fixed contact half b; in contrast, there is a potential difference of Δφ=0.7 U between the two ends of the insulation material cylinder 14a which is disposed on the moving contact half a. In this way, there is an asymmetrical distribution of voltage on the vacuum interrupter, whereby the voltage load Uₐ on the half a of the moving contact rod 9 of the VSR is higher than the voltage load U_{b} on the half b of the stationary contact rod 10 of the VSR, here: Uₐ/U_{b}=7/3.

FIGS. 3 to 7 show sections through vacuum interrupters 1 according to the invention, which are disposed within a grounded metallic “dead tank” hosing. For the sake of simplification of the figures, the illustration of the “dead tank” housing has however been dispensed with in FIGS. 3 to 7; the arrangement of the vacuum interrupters 1 according to the invention in the “dead tank” housing corresponds to the arrangement shown in FIG. 1.

FIG. 3 shows a first embodiment of the vacuum interrupter 1 according to the invention. The vacuum interrupter 1 according to the invention corresponds to a conventional vacuum interrupter 1 as is illustrated in FIGS. 1 and 2, the overall length being in particular identical too, with the following exception: The vacuum interrupter 1 according to the invention in the moving contact half a has an isolator component Iₐ which is longer than the isolator component I_{b} in the fixed contact half b (asymmetrical layout). The isolator component Iₐ in the moving contact half a, and the isolator component I_{b} in the fixed contact half b are in each case formed from identical insulation material hollow cylinders 14 with a length L measured along the rotation axis of the insulation material hollow cylinders 14. The isolator component Iₐ in the moving contact half a is formed from two insulation material hollow cylinders 14a and 14a.2, which are joined to one another and each have a length L, and thus has a length x=2L. The isolator component I_{b} in the fixed contact half b is formed from a single insulation material hollow cylinder 14b with the length L, and thus has a length y=L.

In terms of the lengths x, y of the isolation components Iₐ, I_{b} in the moving contact half a and the fixed contact half b, the following thus applies: x≠y and x>y (asymmetrical layout). By disposing the additional insulation material hollow cylinder 14a.2 in the moving contact half a, the moving contact flange 16 is dispensed with. An additional shielding element 21, which can serve to improve dielectric properties of the VSR or as vapor deposition protection, is disposed between the insulation material hollow cylinder 14a, which adjoins directly the metal hollow cylinder 13, and the additional insulation material hollow cylinder 14a.2.

The fixed contact 3 and the first cover 7 electrically connected thereto are situated on a first electrical potential φ₁. The moving contact 4 and the second cover 8 electrically connected thereto are situated on a second electrical potential φ₂. In the present example, the first potential φ₁ has the value 0 (Volt), the second potential φ₂ has the value U (Volt). An electric field simulation of the vacuum interrupter 1, in which x=2y, has demonstrated that this results in the voltage distribution shown in FIG. 3: The metal hollow cylinder 13 lies on a third electrical potential φ₃ of 0.3 U. There is thus a potential difference (=voltage) of Δφ=0.3 U between the two ends of the isolator component I_{b} which is disposed on the fixed contact half b; in contrast, there is a potential difference of Δφ=0.7 U between the two ends of the isolator component Iₐ which is disposed on the moving contact half a. In this way, there continues to be an asymmetrical distribution of voltage on the vacuum interrupter 1; however, the higher potential difference of Δφ=0.7 which is present in the moving contact half a now decreases over an isolation section which is double the length in comparison to the potential difference of Δφ=0.3 U which is present in the fixed contact half b. As a result of the asymmetrical layout of the electrical isolation, i.e. the use of a different number of insulation material hollow cylinders 14 in the moving contact half a and the fixed contact half b of the housing 5, the specific asymmetrical voltage load of VSRs in grounded interrupter housings 18 is better taken into account than hitherto.

FIG. 4 shows a second embodiment of the vacuum interrupter 1 according to the invention. The vacuum interrupter 1 according to the invention corresponds to a conventional vacuum interrupter 1 as is illustrated in FIGS. 1 and 2, with the exception of the following difference: The vacuum interrupter 1 according to the invention in the moving contact half a has an insulation material hollow cylinder 14a with a larger internal diameter Da than the insulation material hollow cylinder 14b in the fixed contact half b.

As a result of the asymmetrical layout, i.e. the use of insulation material hollow cylinders 14 with different internal diameters D in the moving contact half a and the fixed contact half b of the housing 5, the specific asymmetrical voltage load of VSRs in grounded interrupter housings 18 can be better taken into account.

FIG. 5 shows a third embodiment of the vacuum interrupter 1 according to the invention. The vacuum interrupter 1 according to the invention corresponds to a conventional vacuum interrupter 1 as is illustrated in FIGS. 1 and 2, with the exception of the following differences: The vacuum interrupter 1 according to the invention in the moving contact half a has an isolator component Iₐ which i) has a larger internal diameter Dₐ than the isolator component I_{b} in the fixed contact half b, and ii) has a larger length x, measured along the longitudinal axis 17 of the housing 5, than the isolator component I_{b} in the fixed contact half b. The isolator component Iₐ in the moving contact half a, and the isolator component I_{b} in the fixed contact half b are formed from insulation material hollow cylinders 14 of identical length L, measured along the rotation axis of the insulation material hollow cylinders 14. The isolator component Iₐ in the moving contact half a is formed from two insulation material hollow cylinders 14a and 14a.2, which are joined to one another and each have the length L, and thus has a length x=2L. The isolation component I_{b} in the fixed contact half b is formed from a single insulation material hollow cylinder 14b with the length L and thus has a length y=L.

As a result of the asymmetrical layout, i.e. the use of a different number of insulation material hollow cylinders 14 in the moving contact half a and the fixed contact half b of the housing 5, the specific asymmetrical voltage load of VSRs in grounded interrupter housings 18 can be taken into account. Moreover, this takes place in that the insulation material hollow cylinders 14 in the moving contact half a and the fixed contact half b of the housing 5 have different diameters.

FIG. 6 shows a fourth embodiment of the vacuum interrupter according to the invention. The vacuum interrupter 1 according to the invention corresponds to a conventional vacuum interrupter 1 as is illustrated in FIGS. 1 and 2, with the exception of the following differences: The vacuum interrupter 1 according to the invention in the moving contact half a has an isolator component Iₐ which has different internal diameters Dₐ. The isolator component Iₐ, on its one end on which is disposed the metal hollow cylinder 13 that forms the central part 13 of the VSR housing 5, has a first internal diameter D_{a.1}, and on its other end on which is disposed the second cover 8, has a second internal diameter D_{a.2} which is smaller than the first internal diameter D_{a.1}. The isolator component Iₐ is constructed from two insulation material hollow cylinders 14, 14s, 14a.2 which are joined to one another, of which a first 14a is adjacent to the central part 13, and a second 14a.2 is adjacent to the second cover 8, and wherein a shielding element 21 is inserted into the joint between the two insulation material hollow cylinders 14a, 14a. 2. The first insulation material hollow cylinder 14a, which is adjacent to the central part 13, over its entire length measured along the longitudinal axis of the housing 5 has a first constant internal diameter D_{a.1}. In contrast, the second conical insulation material hollow cylinder 14a, which is adjacent to the second cover 8, widens from a comparatively small second internal diameter D_{a.2} to the first internal diameter D_{a.1}.

The internal diameter D_{b} of the isolator component I_{b} in the fixed contact half b is constant over the entire length of the isolator component I_{b}, measured along the longitudinal axis of the housing 5. In this way, at least the first internal diameter D_{a.1} of the isolator component Iₐ in the moving contact half a is different from the internal diameter D_{b} of the isolator component I_{b} in the fixed contact half b.

FIG. 7 shows a further embodiment of the vacuum interrupter according to the invention. The vacuum interrupter 1 according to the invention corresponds to a conventional vacuum interrupter 1 as is illustrated in FIGS. 1 and 2, with the exception of the following differences:

First, the vacuum interrupter 1 according to the invention in the moving contact half a has an isolator component Iₐ which is longer than the isolator component I_{b} in the fixed contact half b (asymmetrical layout). The isolator component Iₐ in the moving contact half a is constructed from two insulation material hollow cylinders 14a and 14a.2 which are joined to one another and each have a length L, of which a first insulation material hollow cylinder 14a is adjacent to the dividing plane 19 between the moving contact half a and the fixed contact half b, and a second insulation material hollow cylinder 14a.2 is adjacent to the second cover 8; the isolator component Iₐ thus has a length x=2L. The isolator component I_{b} in the fixed contact half b is formed from a single insulation material hollow cylinder 14b with a length L, and thus has a length y=L.

Second, a metallic hollow cylinder 13, which serves as a switching chamber, is not disposed between the isolator components Iₐ and I_{b}, which can be configured e.g. as ceramics, as in the vacuum interrupters shown in FIGS. 1 to 6, but within the isolator components Iₐ and I_{b}. When viewed from the longitudinal axis 17 of the VSR 1, the metallic hollow cylinder 13 serving as a switching chamber is thus positioned in front of the inner shell face of the isolator components Iₐ and I_{b}.

The metallic hollow cylinder 13 serving as a switching chamber herein is held by a holding device, e.g. an encircling metallic annular disk, which is inserted into and fastened in the dividing plane 19 between the isolator component Iₐ in the moving contact half a and the isolator component I_{b} in the fixed contact half b.

1-9. (canceled)

10. A housing for a vacuum interrupter, the housing comprising:
an interior for receiving an axially movable moving contact rod supporting a moving contact and a fixed contact rod supporting a fixed contact;
an arrangement of said contact rods in the housing defining a division of the housing into a moving contact half and a fixed contact half;
in each of said moving contact half and said fixed contact half, a portion of the housing enclosing a longitudinal axis of the housing being formed by an electrically insulating isolator component;
said isolator component in said moving contact half and said isolator component in said fixed contact half having mutually different dimensions.

11. The housing according to claim 10, wherein said isolator components in said moving contact half and said fixed contact half, when measured along the longitudinal axis of the housing, have different lengths.

12. The housing according to claim 11, wherein said isolator component in said moving contact half is longer than said isolator component in said fixed contact half.

13. The housing according to claim 11, wherein said isolator component in said moving contact half and said isolator component in said fixed contact half have mutually different internal diameters.

14. The housing according to claim 13, wherein an internal diameter of said isolator component in said moving contact half is greater than an internal diameter of said isolator component in said fixed contact half.

15. The housing according to claim 11, wherein each of said isolator components is formed by one insulation material hollow cylinder or by a plurality of insulation material hollow cylinders joined to one another.

16. The housing according to claim 11, which comprises a metallic hollow cylinder disposed between said isolator component in said moving contact half and said isolator component of said fixed contact half.

17. A vacuum interrupter, comprising a housing according to claim 10.

18. The vacuum interrupter according to claim 17, further comprising a metallic housing enclosing the vacuum interrupter.
